(19) United States
(12) Patent Application Publication
(10) Pub. No.: US 2007/0077662 A1
(43) Pub. Date: Apr. 5, 2007

(54) APPARATUS AND METHOD FOR MEASURING 8-OHdG

(76) Inventors: Yohei Inaba, Ibaraki (JP); Kenji Yokoyama, Ibaraki (JP); Isao Karube, Ibaraki (JP); Narushi Ito, Tokyo (JP)

Correspondence Address: JHK LAW, P.O. BOX 1078, LA CANADA, CA, 91012-1078, US

(21) Appl. No.: 11/470,955

(22) Filed: Sep. 7, 2006

(30) Foreign Application Priority Data
Sep. 30, 2005 (JP) JP2005-286662
Sep. 1, 2006 (JP) JP2006-237172

(51) Int. Cl. G01N 1/18

(52) U.S. Cl. 436/178

(57) ABSTRACT

<Problem to be Solved>To provide a method for effectively and simply separating and condensing 8-OHdG which is present by a trace amount in body fluid, particularly in urine, and is frequently mingled with foreign substances with their peaks appearing around the peak thereof, a simple measurement method of 8-OHdG, and an apparatus for the measurement. [Solution]The present invention provides a method for effectively and simply separating and condensing 8-OHdG by an optimum combination of chromatographies. Specifically, the present invention comprises a method for separating and condensing 8-hydroxy-2′-deoxyguanosine (8-OHdG) from a body fluid, wherein a urine sample is contacted with a hydrophobic adsorbent which has, as the functional group, a straight chain hydrocarbon group having a carbon number of 6-30 and has a C % of 18% or less to capture the 8-OHdG. The method for measuring 8-OHdG and the apparatus for the measurement method according to the present invention use electrochemical reaction to measure the amount of 8-OHdG in the sample.

### BACKGROUND OF THE INVENTION

1. Field of the Invention

The present invention relates to a method for measuring 8-hydroxy-2′-deoxyguanosine and an apparatus for measuring. More specifically, the present invention relates to a method for pre-treating to measure 8-hydroxy-2′-deoxyguanosine from a body fluid, particularly a urine sample, a method for measuring 8-hydroxy-2′-deoxyguanosine using an electrochemical reaction, and an apparatus for measuring.

Further, the present invention claims a priority of an earlier application of Japanese Patent Application No. 2005-286662 and 2006-237172 incorporated herein by reference.

2. Related Background of the Invention

8-hydroxy-2′-deoxyguanosine (hereafter, sometimes referred to as 8-OHdG) is a substance excreted in body fluid, particularly in urine as a reaction product which 2-deoxyguanosine that is a DNA constituent in cells is exposed to oxidative stress to react with a reactive oxygen seed/free radical to yield. It has been known that generally, environmental chemicals, ultraviolet ray, and ionizing radiation generate an exogenous active oxygen, while disordered lifestyles which are said to trigger cancers or adult-onset diseases generate an endogenous active oxygen, thereby to increase 8-OHdG level. As concrete examples, increase in 8-OHdG level has been reported with regard to large intestine cancer, lung cancer, pediatric cancer, diabetes, chronic hepatitis, coronary artery disease, Alzheimer disease, atopic dermatitis, smoking and alcohol. Meanwhile, reduction in 8-OHdG level by ingestion of Vitamin E, Vitamin C, beta-carotene, curcumin, green tea, red wine, tomato sauce and sprout has been reported. In addition, researches have been promoted to detect degree of DNA damage accompanied by generation of active oxygen after physical exercises. As mentioned, 8-OHdG is most highly recognized as the oxidative stress marker and is used extensively as the oxidative DNA damage marker. Measurements of 8-OHdG are normally performed by HPLC-ECD method which uses an electrochemical detector (ECD) connected to high-performance liquid chromatography (HPLC).

8-OHdG is attempted to measure in the urinary level, though it can be measured using organs, cultured cells and blood-derived cells such as peripheral blood leukocytes (Non-patent document 1). Methods for analysis of urinary 8-OHdG level reported till date is largely classified into three types. 1) An affinity column which is bound with antibody against 8-OHdG is used to purify and give a fraction, which is then analyzed by HPLC-ECD method (Non-patent document 2); 2) Three columns are connected and switched to each others to separate 8-OHdG, followed by detecting by an electrochemical detector (ECD) (Patent documents 1-3, Non-patent document 3); 3) Urine is directly analyzed by ELISA (Patent documents 4, Non-patent document 4).

However, the above-mentioned methods have their respective drawbacks. Above-mentioned method 1) can not be used normally since affinity columns are not commercially available, and further is so low in collection rate that it needs a radioactive internal standard substance to calculate a urinary level. Above-mentioned method 2) needs a complicated pretreatment and is also unclear in collection rate. Foreign substances appear frequently around the peak of 8-OHdG and measured values are depending on research laboratories. Above-mentioned method 3) is not free from a problem of specificity, and thus is reported to give a measurement value eight times higher than those obtained by HPLC-ECD method and a significantly scattering data (Non-patent document 5).

[Patent document 1] Japanese Patent Application Laid-Open No. H08-18992

[Patent document 2] Japanese Patent Application Laid-Open No. 2000-310625

[Patent document 3] Japanese Patent Application Laid-Open No. 2001-258597

[Patent document 4] Japanese Patent Application Laid-Open No. H04-135484

[Non-patent document 1] Kasai et al., Mutation Res., 387, 147-163, 1997

[Non-patent document 2] Park et al. Proc. Natl. Acad. Sci. USA, 89, 3375-3379, 1992

[Non-patent document 3] Loft et al. Carcinogenesis, 13, 2241-2247, 1992

[Non-patent document 4] Erhola et al., FEBS Lett., 9, 287-291, 1997

[Non-patent document 5] Prieme et al., Natural antioxidants and food quality in atherosclerosis and cancer prevention (Kumpulainen et al., eds.), The Royal Society of Chemistry, pp78-82, 1996

[Non-patent document 6] Kato et al., Nephrol Dial Transplant., 18, 931-936, 2003

[Non-patent document 7] Inoue et al., J Health Sci., 49, 217-220, 2003

[Non-patent document 8] Suzuki et al., J Epidemiol. 13, 29-37, 2003

### SUMMARY OF THE INVENTION

Problem to be Solved by the Invention

The present invention provides a method for effectively and simply separating and condensing 8-OHdG which is present by a trace amount in a body fluid, particularly in a urine and has a peak around which those of foreign substances appear frequently, a simplified method for measuring 8-OHdG, and an apparatus for the method.

Means for Solving the Problems

The present invention is characterized in that a method for effectively and simply separating and condensing 8-OHdG by an optimum combination of chromatographies is provided. Further, the present invention is characterized in that a method for simply measuring 8-OHdG utilizing electrochemical reaction and an apparatus for the method are provided.

The present invention comprises:

1. A method for separating and condensing 8-hydroxy-2′-deoxyguanosine (8-OHdG) from a body fluid, wherein the body fluid sample is contacted with a hydrophobic adsorbent which has, as the functional group, a straight chain hydrocarbon group having a carbon number of 6-30 and has a C % of 18% or less to capture the 8-OHdG.

2. The method according to previous item 1, wherein the hydrophobic adsorbent has a particle size diameter of 10-75 μm.

3. The method according to previous item 1, wherein the condensing is performed by reverse-phase chromatography.

4. The method according to previous item 1, wherein the hydrophobic adsorbent is a silica gel chemically bound with an octadecyl group, where a buffer solution containing 0-5% ethanol is used for the washing solution and a buffer solution containing 5-20% ethanol is used for the eluent solution.

5. The method according to previous item 4, wherein the silica gel has a particle size diameter of 60 μm or less.

6. The method according to previous item 1, wherein the body fluid is contacted with the hydrophobic adsorbent to give a sample containing 8-OHdG, which is then contacted with a cation exchanger to collect 8-OHdG.

7. A method for separating and condensing 8-OHdG from a body fluid, wherein the body fluid sample is contacted with a hydrophobic adsorbent which has, as the functional group, a straight chain hydrocarbon group having a carbon number of 6-30 and has a C % of 18% or less to elute a sample containing 8-OHdG, which is then contacted with a cation exchanger to collect 8-OHdG.

8. A condensed 8-OHdG sample for examining obtained by the method according to any one of previous items 1, 6, and 7.

9. A method for measuring 8-OHdG, wherein the condensed 8-OHdG sample for examining obtained by the method according to any one of previous items 1, 6, and 7 is used to analyze.

10. A method for measuring 8-OHdG, wherein the condensed 8-OHdG sample for examining obtained by the method according to any one of previous items 1, 6, and 7 is used to analyze by high-performance liquid chromatography (HPLC).

11. A method for measuring 8-OHdG amount in a sample, wherein electrodes are immersed in the 8-OHdG condensed sample for examining obtained by the method according to any one of previous items 1, 6, and 7 and applied with a constant voltage to detect an electric current.

12. A reagent kit for pre-treating 8-OHdG for use in the method according to previous item 1, comprising a column container filled with a hydrophobic adsorbent which has, as the functional group, a straight chain hydrocarbon group having a carbon number of 6-30 and has a C % of 18% or less, a washing solution for the hydrophobic adsorbent, an eluent solution for eluting from the hydrophobic adsorbent, a column container filled with a cation exchanger, and a developing solution for the cation exchanger.

13. A kit for measuring 8-OHdG, comprising the reagent kit for pre-treating according to previous item 12, a column for HPLC filled with a reverse-phase carrier having a carbon number of 18-30, and a buffer solution having a pH of 6-9 for a mobile phase.

14. A pretreatment apparatus for separating and condensing 8-OHdG in the body fluid sample capable of executing at least the following working processes:

(1) A process for contacting the body fluid sample with a hydrophobic adsorbent which has, as the functional group, a straight chain hydrocarbon group having a carbon number of 6-30 and has a C % of 18% or less;
(2) A process for washing the hydrophobic adsorbent in the process (1) with 0-5% ethanol buffer solution;
(3) A process for eluting a sample containing 8-OHdG from the hydrophobic adsorbent washed in the process (2) by a 5-20% ethanol buffer solution; and
(4) A process contacting the sample containing 8-OHdG eluted in the process (3) with a cation exchanger to collect 8-OHdG.
   15. A system for measuring 8-OHdG, comprising the pretreatment apparatus according to previous item 14 and an HPLC analysis apparatus.
   16. An apparatus for measuring 8-OHdG in a sample capable of executing at least the following working processes:
(1) A process for contacting the body fluid sample with a hydrophobic adsorbent which has, as the functional group, a straight chain hydrocarbon group having a carbon number of 6-30 and has a C % of 18% or less;
(2) A process for washing the hydrophobic adsorbent in the process (1) with 0-5% ethanol buffer solution;
(3) A process for eluting a sample containing 8-OHdG from the hydrophobic adsorbent washed in the process (2) by a 5-20% ethanol buffer solution;
(4) A process contacting the sample containing 8-OHdG eluted in the process (3) with a cation exchanger to collect 8-OHdG; and
(5) A process for immersing electrodes in the solution containing 8-OHdG collected in the process (4) and applying the electrodes with a constant voltage to detect an electric current.
   17. The apparatus according to previous item 16, wherein the hydrophobic adsorbent, the cation exchanger and the electrodes are mounted exchangeable.
   18. The method according to previous item 2, wherein the condensing is carried out by reverse-phase chromatography.
   19. The method according to previous item 2, wherein the hydrophobic adsorbent is a silica gel chemically bound with an octadecyl group, where a buffer solution containing 0-5% ethanol is used for the washing solution and a buffer solution containing 5-20% ethanol is used for the eluent solution.
   20. The method according to previous item 11, wherein the sample is a condensed 8-OHdG sample for examining obtained by the method according to claim 4.
   Effect of the Invention

The method for separating and condensing of the present invention allows pre-treating a sample containing 8-OHdG to remove foreign substances in a body fluid, particularly in a urine sample, and identifying/quantifying in a simple HPLC system. Further, ethanol is selected to use in an eluent solution, allowing omission of an operation for condensing a sample under a reduced pressure, thereby shortening a pretreatment time. Besides, electrochemical reaction is utilized in the method and the apparatus for measuring 8-OHdG of the present invention, allowing simple and effective measurement of the amount of 8-OHdG in a sample containing 8-OHdG.

### DESCRIPTION OF THE PREFERRED EMBODIMENTS

One aspect of the present invention relates to a method for separating and condensing 8-hydroxy-2′-deoxyguanosine (8-OHdG) from a body fluid, wherein the body fluid sample is contacted with a hydrophobic adsorbent which has, as the functional group, a straight chain hydrocarbon group having a carbon number of 6-30 and has a C % of 18% or less, preferably 15% or less, and has more preferably a capped terminal group to capture the 8-OHdG. In other words, the present invention is a method for effectively separating and condensing 8-OHdG from a body fluid sample in order to measure the 8-OHdG that is an oxidative stress marker.

Here, the pretreatment in the present invention denotes a treatment comprising a process for contacting a body fluid sample with a hydrophobic adsorbent (first step) and a succeeding process for contacting with cation exchanger (second step). 8-OHdG in the body fluid is effectively separated and condensed by the pretreatment of the present invention. Further, although the body fluid sample is primarily a urine, the other body fluid such as blood serum also can be selected to provide an effect of the present invention. The serum, which contains 8-OHdG at a normal level of as little as 1/100 times the urinary level, needs a further condensation operation. A serum sample pretreated according to the present invention can be condensed by 100 times, for example, by blowing in a heat block at 50° C. under a nitrogen gas stream to evaporate solvents, allowing clear observation of a peak of 8-OHdG in the serum. Moreover, collected intact urine also can be used. The urine is preferably condensed immediately after collected, but may be generally done within several hours to several days. The urine is sufficiently collected by an amount of 0.5-50 mL, preferably 1.0-10 mL, more preferably 1.5-5.0 mL.

The carrier for contacting the urine with a capture substance is preferably a column, but may be shaped for a batch method. The Capture substance is a substance capable of arresting at least 8-OHdG, and a hydrophobic adsorbent is preferably exemplified. Preferably, the hydrophobic adsorbent has relatively little hydrophobicity to have a monomeric bond. Further, the silica gel chemically bound with an octadecyl group is preferably used. Furthermore, the silica gel has preferably a particle size diameter of 60 μm or less. The hydrophobic adsorbent has a functional group having a carbon number of 6-30, preferably 8-22, more preferably 10-20 to hold 8-OHdG appropriately. The hydrophobic adsorbent has a C % of 18% or less, preferably 15% or less to keep appropriate hydrophobicity. Thus, the urine sample is contacted with the hydrophobic adsorbent according to the present invention to effectively capture 8-OHdG.

The body fluid sample is preferably contacted with the hydrophobic adsorbent according to the present invention by means of reverse-phase chromatography to capture 8-OHdG. Reverse-phase chromatography is a system wherein the stationary phase is less polar than the mobile phase, and typically, it is known that silica gel chemically bound with an octadecyl (ODS) group is combined to use with a water-acetonitrile mixed solvent. In this system, solutes are captured by the stationary phase by way of hydrophobic bond, and higher hydrophobic solutes are eluted later. According to the present invention, the body fluid sample is contacted with a previously conditioned carrier for reverse-phase chromatography, and then a selected washing solution is used to wash non-captured substances away. Meanwhile, the non-captured substances are foreign substances which are not captured by the hydrophobic adsorbent or inhibit measurements of 8-OHdG.

The hydrophobic adsorbent is sufficiently conditioned with water and alcohol. The washing solution is a buffer solution (e.g., phosphate buffer solution) adjusted to have a pH of 5.5-8.5, preferably 6-8, more preferably 6.5-7.5, and contains a solvent such as ethanol, acetonitrile, or methanol at a concentration of approximately 0-5%, preferably 1-4%, more preferably 1-3% (W/V). The washing solution is sufficiently used at an amount of approximately 1-100 mL, preferably 1-50 mL, more preferably 1-20 mL. After washing, an eluent solution is then developed to elute the target 8-OHdG. The eluent solution contains ethanol, acetonitrile, methanol or the like at a concentration of 5% (W/V) or more in an equivalent buffer solution as described above. The concentration is normally 5-20%, preferably 6-10%. The eluent solution is passed through by 2.5-10 mL, and 1 mL eluted between 1.5-2.5 mL is collected. Meanwhile, the eluent solution and the collected solution may be experimentally varied in amount depending on a column size, a sample amount and the like.

The sample containing 8-OHdG collected after contact with the hydrophobic adsorbent is then contacted with a cation exchanger, preferably a strong acid cation exchanger, to adsorb foreign substances in order to collect the target 8-OHdG. The cation exchanger may be a generally known ion exchanger, and is not limited in particular. As the preferred cation exchanger, a strong acid cation exchanger is exemplified, and an exchanger introduced with a sulfonate group is exemplified. Further, as the preferred group, a benzenesulfonate group is exemplified.

The method for contacting with the cation exchanger is not limited specifically, and may be a batch method or a column method. The column method is preferred. Preferably about 1 mL of the sample containing 8-OHdG eluted after contacting with the hydrophobic adsorbent is contacted with the cation exchanger. The cation exchanger is conditioned in advance, that is, treated with sufficient water and alcohol, and is equilibrated with a buffer solution (e.g., a phosphate buffer solution) which is adjusted to pH 5.5-8.5, preferably 6-8, more preferably 6.5-7.5 and contains an alcohol such as ethanol, acetonitrile, and methanol at a concentration of 6% (W/V) or more, preferably 7% (W/V) or more, and more preferably 8% (W/V) or more. The cation exchanger needs to contain the ethanol at a concentration which is same to or more than what the eluate solution from the hydrophobic adsorbent contains. Namely, the concentration is normally 5-40%, preferably 6-30%, more preferably 7-30%.

According to the column method, the sample is loaded on the conditioned cation exchanger, and then developed with a developing solution. The developing solution may be identical or nearly identical with the conditioning solution for the cation exchanger. 1-10 mL of the developing solution is passed through to collect about 1.5 mL of the selected eluate solution eluted between 0.5 and 2.0 mL. Meanwhile, the developing solution and the collected solution may be experimentally varied in amount depending on a column size, a sample amount and the like.

The collected solution contains 8-OHdG at a condensed concentration, and the solvent is appropriately removed to allow quantification of 8-OHdG. For the quantification of 8-OHdG, measurement method by HPLC is mentioned. As shown in FIG. 2, 8-OHdG can be confirmed as a single peak by HPLC fractination.

The method for separating and condensing 8-OHdG of the present invention allows reliable and simple measurements of 8-OHdG. A column container filled with a hydrophobic adsorbent which has, as the functional group, a straight chain hydrocarbon group having a carbon number of 6-30 and has a C % of 18% or less, preferably 15% or less, a washing solution for the hydrophobic adsorbent, an eluent solution for the hydrophobic adsorbent, a column container filled with an ion exchanger, particularly a strong cation exchanger, and an eluent solution for the ion exchanger, particularly an eluent solution for a strong cation exchanger, can be combined to use as a reagent kit for pre-treating 8-OHdG.

Further, the reagent kit for pre-treating, an HPLC column filled with a reverse-phase carrier having a carbon number of 18-30, and a buffer solution (pH 6-9) for the mobile phase can be comprised to use as a kit for measuring 8-OHdG.

One aspect of the present invention is a method for measuring 8-OHdG amount in a sample containing 8-OHdG utilizing electrochemical reaction. This measurement method is based on the result that total electric current of pretreatment fractions obtained in Example 8 is proportional to the amount of 8-OHdG. More particularly, this is a method for detecting an electric current accompanying the oxidation or reduction of 8-OHdG by electrochemical reaction. As a preferred embodiment of this measurement method, a measurement method utilizing electric current detection type chemical sensor is mentioned.

According to the measurement method, 8-OHdG to measure is oxidized or reduced by using an electrochemical reaction to be accompanied by an electric current, which is detected to determine directly the concentration of the 8-OHdG. In particular, for example, a conductive electrode such as platinum and carbon is used as a work electrode and is applied with a predetermined potential difference in connection with a reference electrode composed of silver/silver chloride electrodes to generate an electric current which corresponds to the amount of 8-OHdG contained in a sample. As a condition for this measurement, the two-electrode system composed of a work electrode and a counter electrode is preferably used, and for a more accurate measurement, the three-electrode system of a work electrode, a counter electrode, and a reference electrode is particularly preferred.

Besides, one aspect of the present invention is a pretreatment apparatus for separating and condensing 8-OHdG. The measurement apparatus is based on principle of separation shown in Example 1 and the result that total electric current of pretreatment fractions obtained in Example 8 was proportional to the amount of 8-OHdG. The measurement apparatus comprises, as shown in FIG. 9, at least three liquid tanks [body fluid (urine) sample (1 in FIG. 9), 0-5% ethanol buffer solution (2 in FIG. 9) and 5-20% ethanol buffer solution (3 in FIG. 9)], a valve means for changing the direction of a flow from the liquid tanks (5 in FIG. 9), a hydrophobic adsorbent (4 in FIG. 9), and a cation exchanger (6 in FIG. 9).

Further, a measurement system of 8-OHdG comprising the pretreatment apparatus and an HPLC analysis apparatus is included in the present invention.

In addition, a measurement apparatus of 8-OHdG comprising the pretreatment apparatus, an electrode (7 in FIG. 9), a means for applying an electrode with a voltage, and a means for detecting electric current across the electrode is also included in the present invention. In the apparatus, for the electrode, a work electrode and a counter electrode are preferably used, and three electrodes of a work electrode, a counter electrode and a reference electrode are particularly preferably used.

More particularly, the apparatus can execute the following working processes, allowing measurement of 8-OHdG amount:

(1) A process for contacting a body fluid (urine) sample with a hydrophobic adsorbent which has, as the functional group, a straight chain hydrocarbon group having a carbon number of 6-30 s and has a C % of 18% or less, preferably 15% or less (a process for loading the sample in FIG. 9, where the valve is closed toward the cation exchanger, and the liquid is drained after contacting with the hydrophobic adsorbent);

(2) A process for washing the hydrophobic adsorbent in process (1) with 0-5% ethanol buffer solution (a process for washing the column in FIG. 9, where the valve is closed toward the cation exchanger, and the liquid is drained after contacting with hydrophobic adsorbent);

(3) A process for eluting a sample containing 8-OHdG from the hydrophobic adsorbent washed in process (2) with 5-20% ethanol buffer solution (a process for measuring 8-OHdG in FIG. 9, where the valve is opened toward the cation exchanger and the liquid flows into the cation exchanger);

(4) A process for contacting the sample containing 8-OHdG eluted in process (3) with the cation exchanger to collect 8-OHdG (a process for measuring 8-OHdG in FIG. 9); and

(5) A process for immersing electrodes into the solution containing 8-OHdG collected in process (4), applying a constant voltage across the electrodes to load 8-OHdG with an electrode reaction on the electrodes, and detecting an electric current corresponding to 8-OHdG amount to quantify (a process for measuring 8-OHdG in FIG. 9).

Further, in the apparatus, the hydrophobic adsorbent which has, as the functional group, a straight chain hydrocarbon group having a carbon number of 6-30 and has a C % of 18% or less (4 in FIG. 9) to contact with a urine sample, the cation exchanger (6 in FIG. 9), and the electrode (7 in FIG. 9) are preferably mounted exchangeable.

### EXAMPLE

The present invention will be explained hereafter referring to examples which are exemplified to represent the best mode for carrying the present invention, and is not limited to them.

### Example 1

<Separation of Urine by Reverse-Phase Column (First Step)>

A column filled with 800 mg of reverse-phase carrier (manufactured by YMC, ODS-AQ) was prepared, and conditioned with ethanol and water passing through in this order. A total 4 mL of a sample in which 3 mL of urine and 1.0 mL of a Buffer solution (80 mM phosphate buffer solution (pH 7.0, 4 mM EDTA)) were mixed was applied on the column, through which 10 mL of 10 mM phosphate buffer solution (pH 7.0, containing 2% ethanol) was then passed as the washing solution, and 3 mL of 10 mM phosphate buffer solution (pH 7.0, containing 8% ethanol) was passed as the eluent solution, to collect 1 mL of the eluate solution from 1.5 to 2.5 mL as an 8-OHdG fraction.

<Collection of 8-OHdG by Cation Exchanger Column (Second Step)>

A column filled with 500 mg of cation exchanger (manufactured by Varian, SCX) was used, and conditioned with ethanol, water, and 10 mM phosphate buffer solution (pH 7.0, containing 8% ethanol) passing through. The 8-OHdG fraction obtained in the first step was applied on the cation exchanger (SCX), through which 10 mM phosphate buffer solution (pH 7.0, containing 8% ethanol) was then passed as the mobile phase. 1.5 mL of the eluted mobile phase from 0.5 to 2.0 mL was collected as an 8-OHdG fraction. This means that the urine sample was condensed two times.

<Measurement by HPLC>

25 μl of the 8-OHdG fraction obtained in the second step was injected in a HPLC system. The HPLC system is composed of, as is the case of HPLC system manufactured by Tosoh Corporation, a deaerating apparatus (SD-8022), a gradient pump (CCPM-II), an automatic sampler (AS-8020), a column oven (CO-8020), and a UV detector (UV-8020), an electrochemical detector (EC-8020) (ECD). The reverse-phase column Hydrospehre C18 (4.6×150 mm, 5 μm, manufactured by YMC) was used as the separation column (FIG. 1). For the mobile phase, 10 mM phosphate buffer solution (pH 7.0, 1 mM EDTA, containing acetonitrile at a final concentration of 2%) and similar phosphate buffer solution containing 8% acetonitrile were used. Analysis was carried out using a linear gradient of these two types of buffer solutions. The gradient was programmed so that 8% acetonitrile solution might become 0% in 0→5 min., 100% in 5→20 min., 100% in 20→25 min., 0% in 25→30 min. Measurements were performed at a flow rate of 1 mL/min., at a wavelength of 254 nm by the UV detector, at an applied voltage by ECD of +500 mV, and at a column oven temperature of 35° C. Time for one measurement including washing was 50 min.

Results of measurements are shown in the chromatogram in FIG. 2. As shown from above in FIG. 2, three patterns of pretreatments, by C18 column manufactured by Agilent for reference, by ODS-AQ processing (in first step only) for reference, and by ODS-AQ and SCX processing (pretreatment of the present invention (first step and second step)), were made to measure by HPLC. First, the urine sample after ODS-AQ processing, which is compared with samples for references processed by C18 column and by ODS-AQ, is sufficiently free from foreign substances and has an electrode response area of 20,000, which is about ¼ as much as that of the sample by C18 column processing, that is, 90,000. The electrode response area was reduced to 3756 by further executing cation exchanger processing (second step). In this instance, the other peaks were reduced around the 8-OHdG peak after the elution, allowing simple identification of 8-OHdG.

### Example 2

This example was carried out in a scale-down way from Example 1. This allows reduction of time for pretreatment. Steps of the pretreatment are as follows:

<Separation of Urine by Reverse-Phase Column (First Step)>

A column filled with 400 mg of reverse-phase carrier (manufactured by YMC, ODS-AQ) was produced, and conditioned with ethanol and water passing through in this order. A total 2 mL of sample in which 1.5 mL of urine and 0.5 mL of Buffer solution (80 mM phosphate buffer solution (pH 7.0, 4 mM EDTA)) were mixed was applied on the column, and 6 mL of 10 mM phosphate buffer solution (pH 7.0, containing 2% ethanol) was passed through as the washing solution. 2 mL of 10 mM phosphate buffer solution (pH 7.0, containing 8% ethanol) was then passed through as the eluent solution, to collect 0.5 mL of the elutate solution from 0.75 to 1.25 mL as an 8-OHdG fraction.

<Collection of 8-OHdG by Cation Exchanger Column (Second Step)>

A column filled with 250 mg of cation exchanger (Varian, SCX) was prepared, and conditioned with ethanol, water, and 10 mM phosphate buffer solution (pH 7.0, containing 8% ethanol) passing through. The 8-OHdG fraction obtained in the first step was applied on the cation exchanger (SCX), and then 10 mM phosphate buffer solution (pH 7.0, containing 8% ethanol) was passed through as the mobile phase. 0.75 mL of the eluted mobile phase from 0.25 to 1.0 mL was collected as an 8-OHdG fraction. This means that the urine sample was condensed two times. This 8-OHdG fraction was subjected to the HPLC system. 8-OHdG could be identified simply as in Example 1.

### Example 3

<Measurement of 8-OHdG Under Simpler HPLC Condition>

In Example 1, the sample processed by the pretreatment of the present invention was measured under an HPLC gradient condition to get a chromatogram, which was then evaluated to give a result that few other peaks were shown around the 8-OHdG peak before 10 minutes (FIG. 2). The present inventors considered that an HPLC condition would be set to suit for the pretreatment, allowing measurement by a simpler system in a short time. We then attempted to change a column size in an isocratic HPLC condition to simplify the system and to shorten a time for measurement.

25 μl of the 8-OHdG fraction obtained in the second step of Example 1 was injected in the HPLC system. The HPLC system was composed of, like the HPLC system manufactured by Tosoh Corporation, a deaerating apparatus (SD-8022), a pump (CCPM-II), an automatic sampler (AS-8020), a column oven (CO-8020), and an electrochemical detector (EC-8020) (ECD). The reverse-phase column Capcellpak™ C18MGII (4.6×100 mm, 3 μm, manufactured by Shiseido Co.) was used as the separation column (FIG. 3). For the mobile phase, 10 mM phosphate buffer solution (pH 7.0, 1 mM EDTA, containing 5% acetonitrile as a final concentration) was used. As a result, a chromatogram as shown in FIG. 4 was obtained. This chromatogram revealed that the time for eluting 8-OHdG was 3 min and one measurement was completed in 15 min, that is to say, the measurement was completed 30 min earlier than the measurement taken under a gradient condition. The HPLC condition suited for the pretreatment of the present invention is used to allow measurement of 8-OHdG in the simpler system.

### Example 4

<Correlation with Conventional Method>

Urine samples were measured by a column switching method already reported (Nakano et al., Free Radic. Biol. Med., 35, 826-832, 2003) and by the method of the present invention as in Examples 2 and 3, thereby to compare for evaluation. Besides, in the same way, the urine samples were measured by Enzyme Linked Immuno-Sorbent Assay (ELISA, manufactured by Nikken Seil) and by the method of the present invention as in Examples 2 and 3, thereby to compare for evaluation. Results of measurements are shown in FIG. 6. The same urine sample was used to ask the correlations of the present method with the column switching method and with ELISA method, resulting in FIG. 6A and FIG. 6B, respectively. In both FIG. 6A and 6B, X-axis represents results of the measurement by the present method and Y-axis represents those obtained by each of the conventional methods. As a result, correlation coefficients of the present method with the column switching method and with the ELISA method were r=0.96, and r=0.86, respectively. These results of the measurement suggest that the method of the present invention can sufficiently quantify 8-OHdG.

### Example 5

This example was carried out in a more scale-down way from Examples 1 and 2. This allows reduction of time for pretreatment. Steps of the pretreatment are as follows:

<Separation of Urine by Reverse-Phase Column (First Step)>

A column filled with 200 mg of reverse-phase carrier (manufactured by YMC, ODS-AQ, particle size 20 μm) was prepared, and conditioned with ethanol and water passing through in this order. A total 1.2 mL of sample in which 0.9 mL of urine and 0.3 mL of Buffer solution (80 mM phosphate buffer solution (pH 7.0, 4 mM EDTA)) were mixed was applied on the column, and 1.5 mL of Liquid A (10 mM phosphate buffer solution (pH 7.0, containing 2% ethanol)) was passed through as the washing solution. 0.7 mL of Liquid B (10 mM phosphate buffer solution (pH 7.0, containing 8% ethanol)) was then passed through as the eluent solution, to collect 0.3 mL of the elutate solution from 0.4 to 0.7 mL as 8-OHdG fraction.

<Collection of 8-OHdG by Cation Exchanger Column (Second Step)>

A column filled with 150 mg of cation exchanger (Varian, SCX) was prepared, and conditioned with ethanol, water, and 10 mM phosphate buffer solution (pH 7.0, containing 8% ethanol) passing through. The 8-OHdG fraction obtained in the first step was applied on the cation exchanger (SCX), and then Liquid B (10 mM phosphate buffer solution (pH 7.0, containing 8% ethanol)) was passed through. 0.75 mL of the eluted Liquid B from 0.15 to 0.9 mL was collected as an 8-OHdG fraction. The fraction thus obtained was a condensed urine sample. The 8-OHdG fraction was subjected to the HPLC system. FIG. 5 shows a series of pretreatment processes throughout the first step and second step. The series of pretreatment processes could be completed in 80-120 min.

### Example 6

<Measurement 2 of 8-OHdG by Simpler HPLC Conditions>

Although simplification of HPLC system and reduction of time for measurement were attempted in Example 3, we considered that further reduction of the time for measurement would be possible. The HPLC chromatograph shown in FIG. 4 was evaluated to indicate that few constituents were eluted earlier than 8-OHdG. Accordingly, we attempted to set a condition for eluting 8-OHdG more rapidly and further to change a column size in order to shorten the time for measurement.

10 μL of the 8-OHdG fraction obtained in the second step of Example 5 was injected in the HPLC system. The HPLC system was composed of, like the HPLC system manufactured by Tosoh Corporation as used in Example 3, a deaerating apparatus (SD-8022), a pump (CCPM-II), an automatic sampler (AS-8020), a column oven (CO-8020), and an electrochemical detector (EC-8020) (ECD). Reverse-phase column Develosil C30 (4.6×50 mm, 3 μm, manufactured by Nomura Chemical) was used as the separation column. For the mobile phase, 10 mM phosphate buffer solution (pH 7.0, 1 mM EDTA, containing 5% acetonitrile as a final concentration) was used. As a result, a chromatogram as shown in FIG. 7 was obtained. This chromatogram revealed that the time for eluting 8-OHdG was 2 min, and one measurement was completed in 9 min, that is to say, the measurement was completed 30 min or more earlier than the measurement taken under a gradient condition.

From the above-mentioned results, the HPLC condition suited for the pretreatment of the present invention is used to allow measurement of 8-OHdG in the simpler system.

### Example 7

<Pretreatment Process>

Outline of the pretreatment process of the first step and second step in Example 5 (FIG. 5) is shown hereafter.

For pretreatment necessary to measure 8-OHdG in a body fluid, particularly in a urine sample, first, the column was filled with 200 mg of ODS-AQ (hydrophobic adsorbent), and then 3 mL of ethanol and 3 mL of distilled water were passed through sequentially to activate.

1. 0.9 mL of the urine sample and 0.3 mL of 80 mM phosphate buffer solution (pH 7.0) (Buffer) containing EDTA at a final concentration of 4 mM were mixed, and applied on the ODS-AQ.

2. 1.5 mL of 10 mM phosphate buffer solution (pH 7.0) (liquid A) containing ethanol at a final concentration of 2% was passed through as the washing solution.

3. Further, 0.4 mL of 10 mM phosphate buffer solution (pH 7.0) (liquid B) containing ethanol at a final concentration of 8% was passed through as the washing solution.

4. 0.3 mL of 10 mM phosphate buffer solution (pH 7.0) (liquid B) containing ethanol at a final concentration of 8% was passed through as the eluent solution to collect the eluate solution.

5. Meanwhile, the column was filled with 150 mg of SCX (cation exchanger), which was then activated in a similar way as ODS-AQ, and the sample collected in process 4. was applied.

6. 0.15 mL of 10 mM phosphate buffer solution (pH 7.0) (liquid B) containing ethanol at a final concentration of 8% was passed through as the washing solution.

7. 0.75 mL of 10 mM phosphate buffer solution (pH 7.0) (liquid B) containing ethanol at a final concentration of 8% was passed through as the eluent solution to collect the eluate solution.

8. The eluate solution obtained in process 7. was subjected to HPLC as the 8-OHdG pretreated solution.

The above pretreatment process can be carried out manually using a pretreatment reagent kit comprising a hydrophobic adsorbent (ODS-AQ column), a cation exchanger (SCX column), liquid A, liquid B and Buffer solution as the necessary members. Besides, the pretreatment apparatus allows automatic execution of processes 3-7.

### Example 8

<Relationship Between Amount of 8-OHdG in Pretreatment Sample and Total Electric Current>

The 8-OHdG in the urine sample subjected to pretreatment according to the method of Example 1 was determined by HPLC method used in Example 3. Further, electrochemical measurement was performed for the pretreatment fraction. Measurement condition used was +500 mV, and electric current after 5 min from start was measured. Results of the measurement were plotted to obtain a graph as shown in FIG. 8, where X-axis represents amount of 8-OHdG and Y-axis represents total electric current of the pretreatment fraction. Correlation was recognized from the graph between 8-OHdG and total electric current. It is demonstrated from this result that total electric current of a pretreatment fraction is measured to allow indirect quantification of the 8-OHdG. Further, the total electric current may be considered as a total electric current of a substance that is contained in the fraction obtained by the pretreatment of Example 1 and applied with a voltage of +500 mV to causes an electrode reaction. Therefore, the total electric current of a pretreated sample is measured on an electrode by an electrochemical method, allowing indirect measurement of 8-OHdG, needless to separate by HPLC.

### INDUSTRIAL APPLICABILITY

The present invention is to provide a simplified method and an apparatus for measuring 8-OHdG, and is extremely useful as an inspection method of oxidative stress. This invention can provide a noninvasive measurement method using urine and an apparatus for the evaluation of an oxidative stress state derived from large intestine cancer, lung cancer, pediatric cancer, diabetes, chronic hepatitis, coronary artery disease, Alzheimer disease, atopic dermatitis, smoking, alcohol, and physical exercises, and for the improvement of an oxidative stress state by way of ingestion of Vitamin E, Vitamin C, beta-carotene, curcumin, green tea, red wine, tomato sauce and sprout.

### BRIEF DESCRIPTION OF THE DRAWINGS

FIG. 1 shows a measurement system.

FIG. 2 shows an HPLC chromatogram in Example 1.

FIG. 3 shows a measurement system.

FIG. 4 shows an HPLC chromatogram in Example 3.

FIG. 5 shows outline of scaled-down pretreatment process.

FIG. 6 shows correlation between present invention and conventional method.

FIG. 7 shows an HPLC chromatogram in Example 6.

FIG. 8 shows relationship between 8-OHdG amount in pretreated sample and total electric current.

FIG. 9 shows outline of apparatus for 8-OHdG measurement according to the present invention.

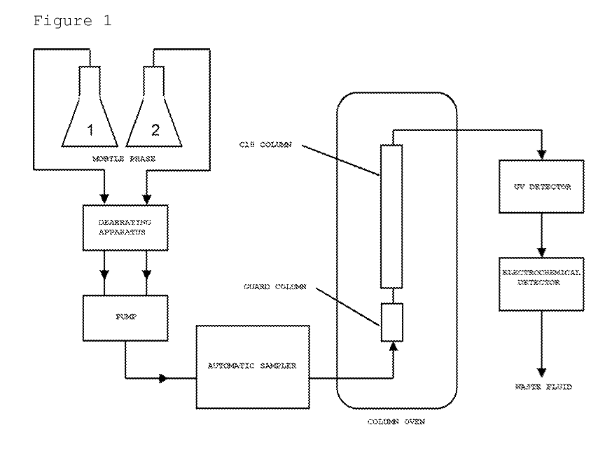

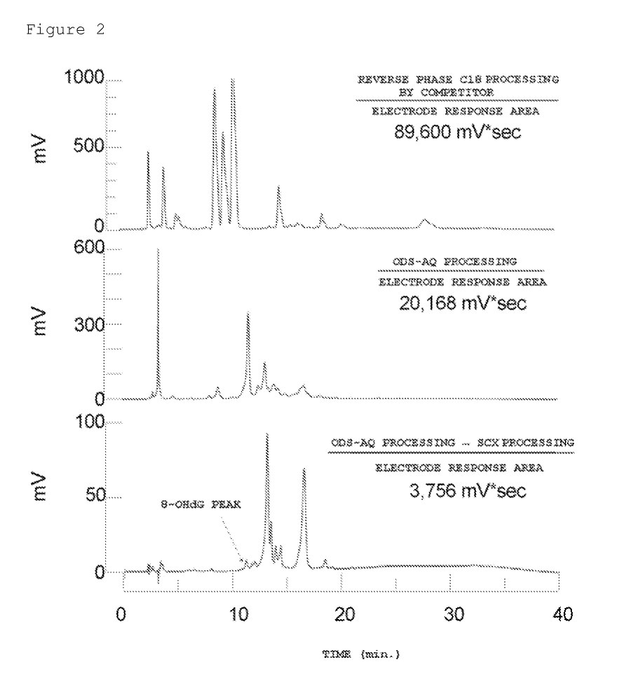

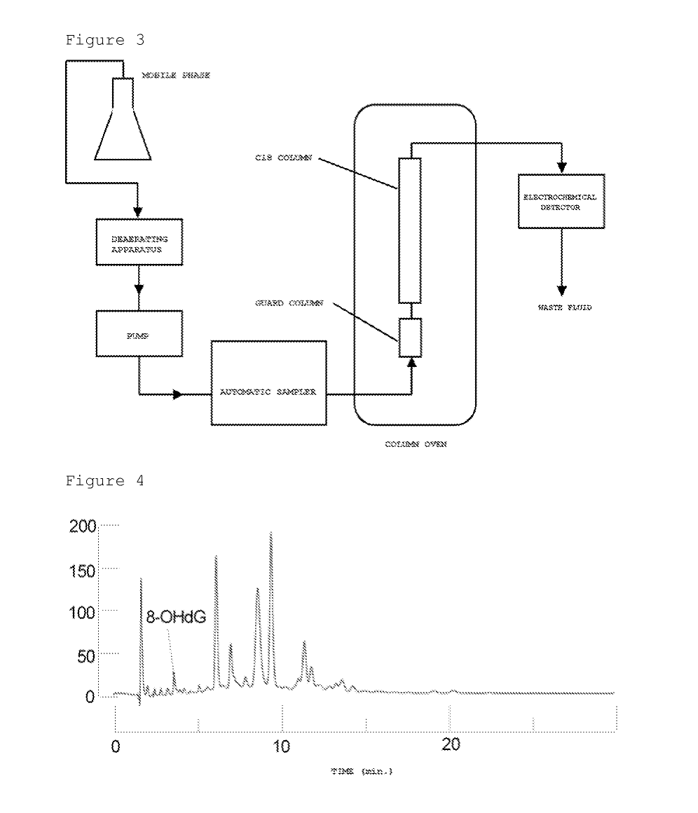

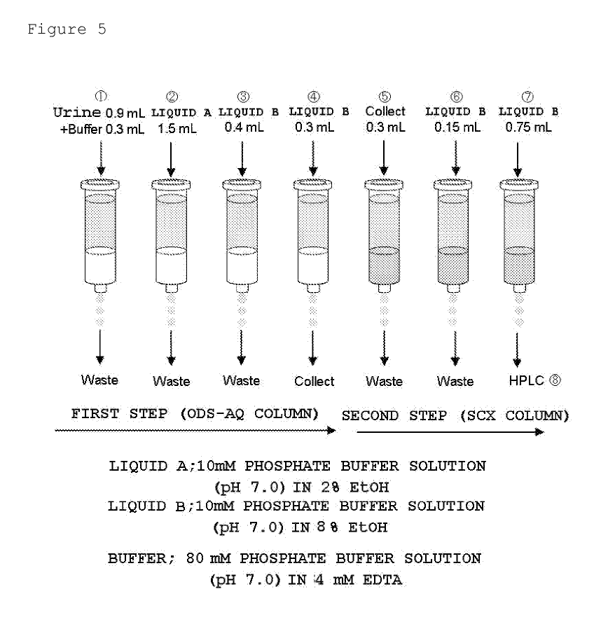

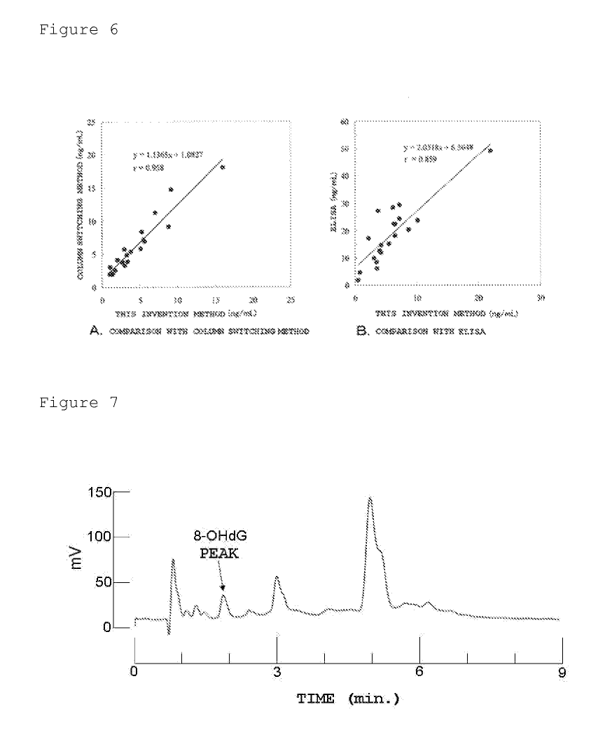

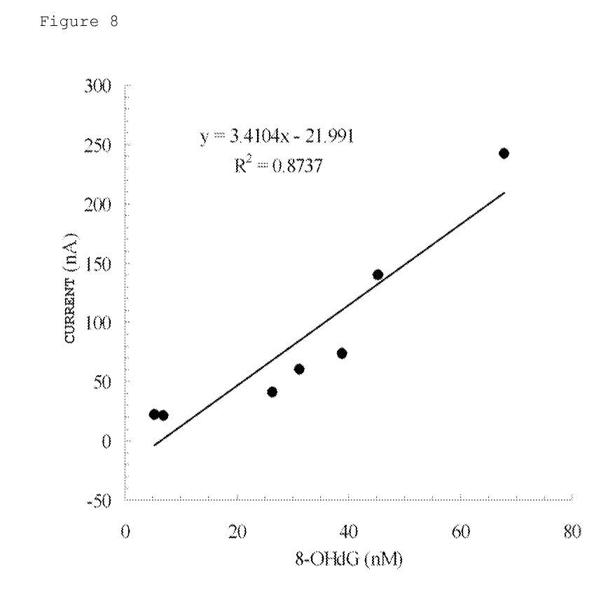

### EXPLANATIONS OF NUMERALS

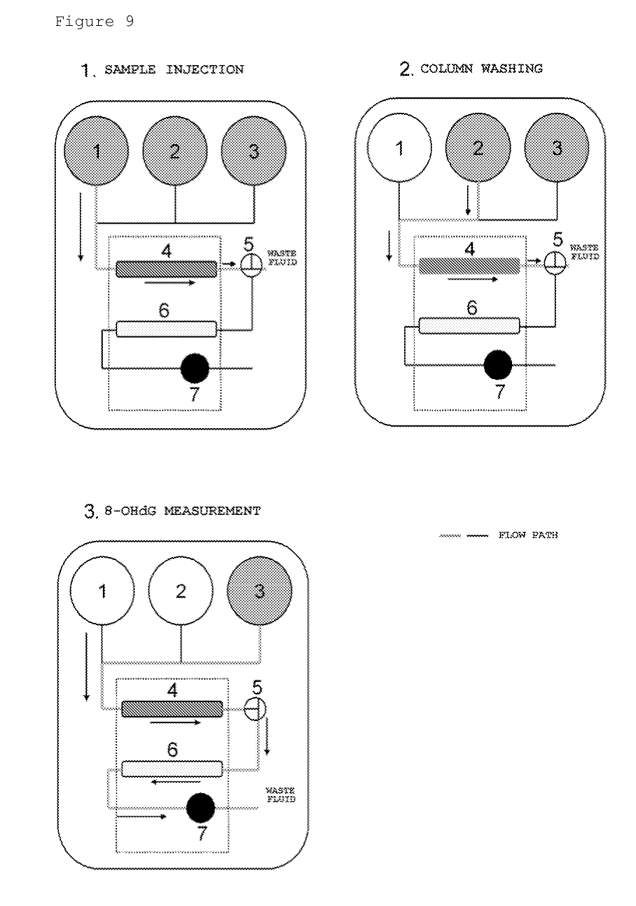

Explanations of numerals used in FIG. 9 are as follows:
1. Urine sample tank
2. 0-5% ethanol buffer solution tank
3. 5-20% ethanol buffer solution tank
4. Hydrophobic adsorbent
5. Valve means
6. Cation exchanger
7. Electrode

What is claimed is:

1. A method for separating and condensing 8-hydroxy-2′-deoxyguanosine (8-OHdG) from a body fluid, wherein the body fluid sample is contacted with a hydrophobic adsorbent which has, as the functional group, a straight chain hydrocarbon group having a carbon number of 6-30 and has a C % of 18% or less to capture the 8-OHdG.

2. The method according to claim 1, wherein the hydrophobic adsorbent has a particle size diameter of 10-75 μm.

3. The method according to claim 1, wherein the condensing is performed by reverse-phase chromatography.

4. The method according to claim 1, wherein the hydrophobic adsorbent is a silica gel chemically bound with an octadecyl group, where a buffer containing 0-5% ethanol is used for the washing solution and a buffer containing 5-20% ethanol is used for the eluent solution.

5. The method according to claim 4, wherein the silica gel has a particle size diameter of 60 μm or less.

6. The method according to claim 1, wherein the body fluid is contacted with the hydrophobic adsorbent to give a sample containing 8-OHdG, which is then contacted with a cation exchanger to collect 8-OHdG.

7. A method for separating and condensing 8-OHdG from a body fluid, wherein the body fluid sample is contacted with a hydrophobic adsorbent which has, as the functional group, a straight chain hydrocarbon group having a carbon number of 6-30 and has a C % of 18% or less to elute a sample containing 8-OHdG, which is then contacted with a cation exchanger to collect 8-OHdG.

8. A condensed 8-OHdG sample for examining obtained by the method according to any one of claims 1, 6, and 7.

9. A method for measuring 8-OHdG, wherein the condensed 8-OHdG sample for examining obtained by the method according to any one of claims 1, 6, and 7 is used to analyze.

10. A method for measuring 8-OHdG, wherein the condensed 8-OHdG sample for examining obtained by the method according to any one of claims 1, 6, and 7 is used to analyze by high-performance liquid chromatography (HPLC).

11. A method for measuring 8-OHdG amount in a sample, wherein electrodes are immersed in the condensed 8-OHdG sample for examining obtained by the method according to any one of claims 1, 6, and 7 and applied with a constant voltage to detect an electric current.

12. A reagent kit for pre-treating 8-OHdG for use in the method according to claim 1, comprising a column container filled with a hydrophobic adsorbent which has, as the functional group, a straight chain hydrocarbon group having a carbon number of 6-30 and has a C % of 18% or less, a washing solution for the hydrophobic adsorbent, an eluent solution for eluting from the hydrophobic adsorbent, a column container filled with a cation exchanger, and a developing solution for the cation exchanger.

13. A kit for measuring 8-OHdG, comprising the reagent kit for pre-treating according to claim 12, a column for HPLC filled with a reverse-phase carrier having a carbon number of 18-30, and a buffer having a pH of 6-9 for a mobile phase.

14. A pretreatment apparatus for separating and condensing 8-OHdG in the body fluid sample capable of executing at least the following working processes:
(1) A process for contacting the body fluid sample with a hydrophobic adsorbent which has, as the functional group, a straight chain hydrocarbon group having a carbon number of 6-30 and has a C % of 18% or less;
(2) A process for washing the hydrophobic adsorbent in the process (1) with 0-5% ethanol buffer solution;
(3) A process for eluting a sample containing 8-OHdG from the hydrophobic adsorbent washed in the process (2) by a 5-20% ethanol buffer solution; and
(4) A process contacting the sample containing 8-OHdG eluted in the process (3) with a cation exchanger to collect 8-OHdG.

15. A system for measuring 8-OHdG, comprising the pretreatment apparatus according to claim 14 and an HPLC analysis apparatus.

16. An apparatus for measuring 8-OHdG in a sample capable of executing at least the following working processes:
(1) A process for contacting the body fluid sample with a hydrophobic adsorbent which has, as the functional group, a straight chain hydrocarbon group having a carbon number of 6-30 and has a C % of 18% or less;
(2) A process for washing the hydrophobic adsorbent in the process (1) with 0-5% ethanol buffer solution;
(3) A process for eluting a sample containing 8-OHdG from the hydrophobic adsorbent washed in the process (2) by a 5-20% ethanol buffer solution;
(4) A process contacting the sample containing 8-OHdG eluted in the process (3) with a cation exchanger to collect 8-OHdG; and
(5) A process for immersing electrodes in the solution containing 8-OHdG collected in the process (4) and applying the electrodes with a constant voltage to detect an electric current.

17. The apparatus according to claim 16, wherein the hydrophobic adsorbent, the cation exchanger and the electrodes are mounted exchangeable.

18. The method according to claim 2, wherein the condensing is carried out by reverse-phase chromatography.

19. The method according to claim 2, wherein the hydrophobic adsorbent is a silica gel chemically bound with an octadecyl group, where a buffer solution containing 0-5% ethanol is used for the washing solution and a buffer solution containing 5-20% ethanol is used for the eluent solution.

20. The method according to claim 11, wherein the sample is a condensed 8-OHdG sample for examining obtained by the method according to claim 4.
